(19) United States
(12) Patent Application Publication
(10) Pub. No.: US 2023/0402723 A1
(43) Pub. Date: Dec. 14, 2023

(54) BATTERY PACK

(71) Applicant: SAMSUNG SDI CO., LTD., Yongin-si (KR)

(72) Inventor: Sanghun PARK, Yongin-si (KR)

(21) Appl. No.: 18/206,705

(22) Filed: Jun. 7, 2023

(30) Foreign Application Priority Data
Jun. 8, 2022 (KR) 10-2022-0069550

(51) Int. Cl. H01M 50/533; H01M 50/54; H01M 10/653

(52) U.S. Cl. CPC H01M 50/533; H01M 50/54; H01M 10/653

(57) ABSTRACT

A battery pack includes a battery cell including an electrode tab drawn out therefrom; a circuit portion electrically connected to the electrode tab; and a conductive thermocompression bonding layer, the conductive thermocompression bonding layer conductively connecting the electrode tab and the circuit portion, and including conductive particles and an insulating resin accommodating the conductive particles, wherein the electrode tab includes at least one accommodation space accommodating the insulating resin therein.

### CROSS-REFERENCE TO RELATED APPLICATION

This application is based on and claims priority under 35 U.S.C. § 119 to Korean Patent Application No. 10-2022-0069550, filed on Jun. 8, 2022, in the Korean Intellectual Property Office, the disclosure of which is incorporated by reference herein in its entirety.

### BACKGROUND

### 1. Field

Embodiments relate to a battery pack.

### 2. Description of the Related Art

In general, secondary batteries are rechargeable unlike non-rechargeable primary batteries. Secondary batteries may be used as energy sources of devices, such as mobile devices, electric vehicles, hybrid vehicles, electric bicycles, or uninterruptible power supplies, and depending on the type of an external device using a secondary battery, the secondary battery may be used as a single battery cell or as a module in which a plurality of battery cells are connected to each other to constitute a unit.

### SUMMARY

The embodiments may be realized by providing a battery pack including a battery cell including an electrode tab drawn out therefrom; a circuit portion electrically connected to the electrode tab; and a conductive thermocompression bonding layer, the conductive thermocompression bonding layer conductively connecting the electrode tab and the circuit portion, and including conductive particles and an insulating resin accommodating the conductive particles, wherein the electrode tab includes at least one accommodation space accommodating the insulating resin therein.

The electrode tab may include a base portion proximate to the battery cell in a first direction in which the electrode tab is drawn out, the base portion not including the at least one accommodation space therein; and a front end portion distal to the battery cell in the first direction, the front end portion including the at least one accommodation space therein.

The at least one accommodation space may be an opening, at least one side of the opening being open at a side of the electrode tab, or a closed hole isolated from the outside of the electrode tab.

The electrode tab may selectively include one of the opening or the closed hole, or may include both the opening and the closed hole.

The at least one accommodation space may include a plurality of accommodation spaces, and the electrode tab may include a plurality of strips, which are alternately arranged with the plurality of accommodation spaces and are a solid portion of the electrode tab.

The plurality of accommodation spaces and the plurality of strips may be alternately arranged in a second direction intersecting with the first direction.

The plurality of accommodation spaces and the plurality of strips may be alternately arranged in the second direction, at the front end portion of the electrode tab.

The electrode tab may further include a burr along a contour line of the electrode tab, the burr of the electrode tab may restrain the conductive particles on the plurality of strips such that the conductive particles are present on the plurality of strips in a relatively high proportion when compared to the insulating resin, and the insulating resin may be present in the plurality of accommodation spaces adjacent to the strips in a relatively high proportion when compared to the conductive particles.

In relative proportions of the conductive particles and the insulating resin of the conductive thermocompression bonding layer, the relative proportion of the conductive particles present on the plurality of strips may be greater than the relative proportion of the conductive particles present in the plurality of accommodation spaces.

In relative proportions of the conductive particles and the insulating resin of the conductive thermocompression bonding layer, the relative proportion of the insulating resin present in the plurality of accommodation spaces may be greater than the relative proportion of the insulating resin present on the plurality of strips.

The front end portion of the electrode tab may have a concave-convex pattern in which the plurality of strips and openings of the plurality of accommodation spaces alternate.

The plurality of strips and the openings may have shapes that are complementary to each other, the plurality of strips may have a variable width along a length of the strips following the first direction, in a second direction intersecting with the first direction, and the openings may have a variable width in a reverse shape in the second direction.

An end of the strip of the concave-convex pattern or an end of the opening, which are opposite to each other in the first direction, may have a rounded shape.

Unit shapes of the plurality of accommodation spaces may be repeatedly arranged at the front end portion of the electrode tab such that the plurality of strips are between adjacent unit shapes.

The unit shapes of the plurality of accommodation spaces may be closed holes.

The unit shapes of the plurality of accommodation spaces may be closed holes at inner positions of the electrode tab, and may be open openings at both ends of the electrode tab at an outer edge of the electrode tab.

The unit shapes may have a closed-loop curve.

The unit shapes may be a circular shape, and a circular shape formed by a closed hole and a semicircular shape formed by an open opening may have a same diameter or a same curvature.

The electrode tab may include a first electrode tab and a second electrode tab having polarities opposite to each other, and the first electrode tab, the second electrode tab, and the circuit portion may be electrically connected to each other through a single conductive thermocompression bonding layer therebetween extending across the first electrode tab and the second electrode tab.

### BRIEF DESCRIPTION OF THE DRAWINGS

FIG. 1 is a perspective view of a battery pack according to an embodiment;

FIG. 2 is an exploded perspective view of the battery pack of FIG. 1;

FIG. 3 is a perspective view of a portion of the battery pack illustrated in FIG. 1;

FIG. 4 is a cross-sectional view taken along line A-A′ of FIG. 3;

FIGS. 5 to 8 illustrate various types of electrode tabs applicable to a battery pack of the disclosure; and

FIG. 9 illustrates a modified embodiment of the battery pack illustrated in FIG. 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the terms “or” and “and/or” are not exclusive terms, and include any and all combinations of one or more of the associated listed items. Expressions such as “at least one of,” when preceding a list of elements, modify the entire list of elements and do not modify the individual elements of the list.

Hereinafter, a battery pack according to an embodiment will be described with reference to the accompanying drawings.

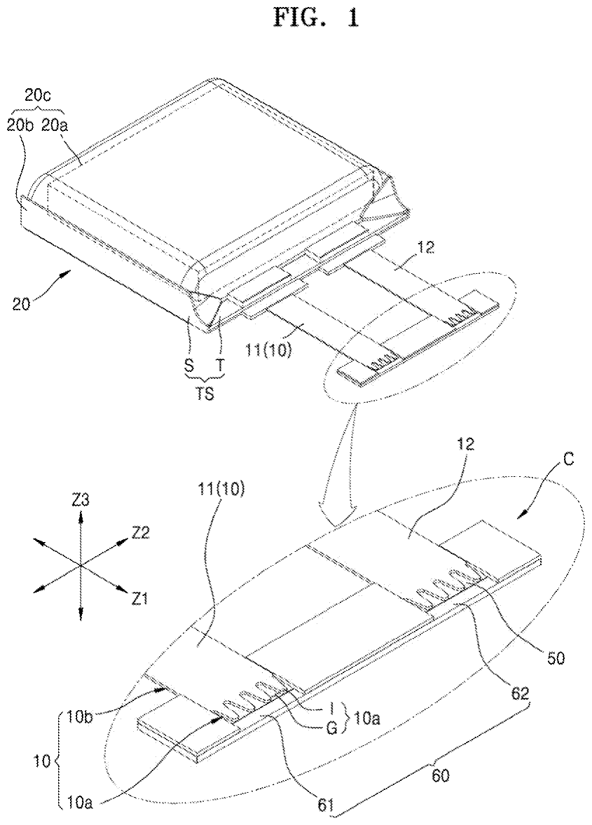

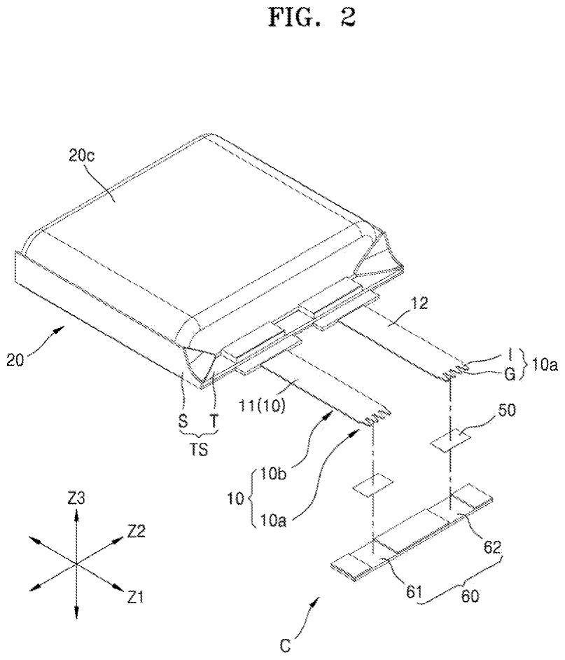

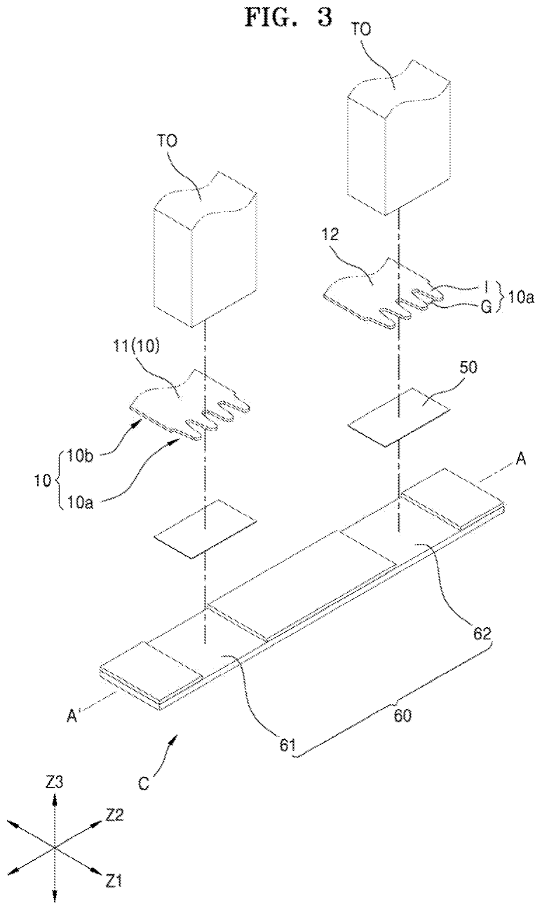

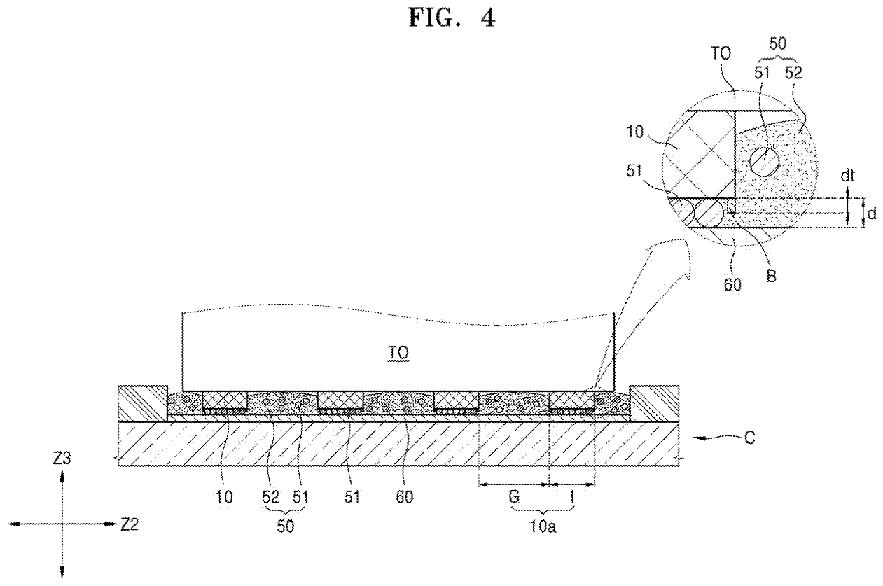

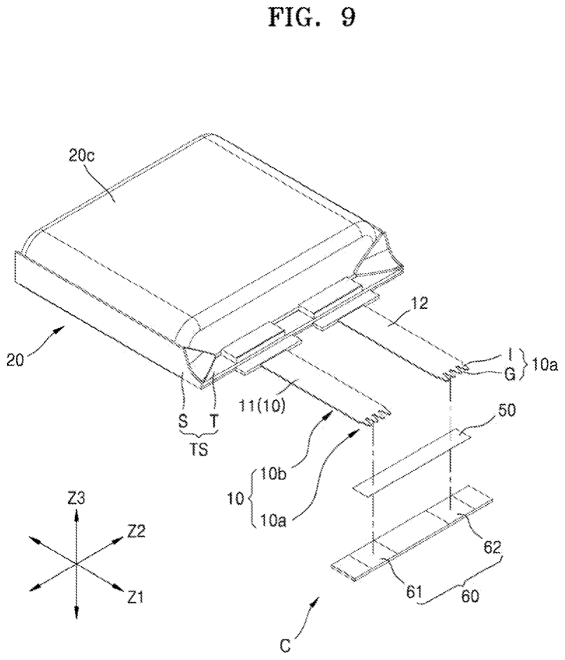

FIG. 1 is a perspective view of a battery pack according to an embodiment. FIG. 2 is an exploded perspective view of the battery pack of FIG. 1. FIG. 3 is a perspective view of a portion of the battery pack illustrated in FIG. 1. FIG. 4 is a cross-sectional view taken along line A-A′ of FIG. 3. FIGS. 5 to 8 illustrate various types of electrode tabs applicable to a battery pack of the disclosure. FIG. 9 illustrates a modified embodiment of the battery pack illustrated in FIG. 2.

Referring to FIGS. 1 and 2, a battery pack according to an embodiment may include a battery cell 20, an electrode tab 10 extending from the battery cell 20 in a first direction Z1, a circuit portion C connected to the electrode tab 10, and a conductive thermocompression bonding layer 50 that mediates or facilitates a conductive connection between the electrode tab 10 and the circuit portion C.

In an implementation, the battery cell 20 may include an electrode assembly 20a and a casing 20b surrounding the electrode assembly 20a. In an implementation, the electrode tab 10 may be drawn out from the battery cell 20 in the first direction Z1, and may include first and second electrode tabs 11 and 12 having different polarities. In this case, the first and second electrode tabs 11 and 12 having different polarities may be arranged (e.g., spaced apart) in a second direction Z2 intersecting with the first direction Z1.

Throughout the present specification, the first and second directions Z1 and Z2 may be defined on a plane on which the battery cells 20 are arranged, the first direction Z1 may refer to a direction in which the electrode tab 10 is drawn from a terrace portion T of the battery cell 20, and the second direction Z2 may refer to a direction in which the first and second electrode tabs 11 and 12 having different polarities are arranged. In an implementation, the first and second directions Z1 and Z2 may correspond to directions that intersect with each other perpendicularly to each other. Throughout the present specification, a third direction Z3 is a direction intersecting with the plane of the first and second directions Z1 and Z2 on which the battery cells 20 are arranged, and may correspond to the thickness direction of the electrode tab 10. In an implementation, the third direction Z3 may correspond to a direction perpendicular to the first and second directions Z1 and Z2.

In an implementation, the electrode assembly 20a may be formed in a winding type in which first and second electrode plates and a separator between the first and second electrode plates are wound in a roll shape, or may be formed in a stack type in which first and second electrode plates and a separator are stacked with respect to each other. The first and second electrode plates of the electrode assembly 20a may be electrically connected to the outside of the casing 20b through the electrode tab 10 of the battery cell 20, and the electrode tab 10 of the battery cell 20 may be electrically connected to the first and second electrode plates of the electrode assembly 20a, respectively, and may include the first electrode tab 11 and the second electrode tab 12 having different polarities.

The casing 20b may surround the electrode assembly 20a, and a sealing portion TS sealing the electrode assembly 20a may be formed by using an excess of the casing 20b remaining after surrounding the electrode assembly 20a. In an implementation, the battery cell 20 may include a main body 20c including the electrode assembly 20a and the casing 20b surrounding the electrode assembly 20a, and the sealing portion TS, which is along the periphery of the main body 20c, and includes the casing 20b sealing the electrode assembly 20a, e.g., the excess of the casing 20b remaining after surrounding the electrode assembly 20a. In an implementation, the sealing portion TS may include the terrace portion T from which the electrode tab 10 is drawn out, and may include, in addition to the terrace portion T, a side sealing portion S formed along a side of the main body 20c of the battery cell 20.

The electrode tab 10 may be drawn out through the terrace portion T of the battery cell 20, and may be electrically connected to the circuit portion C through the conductive thermocompression bonding layer 50. In an implementation, the electrode tab 10 may extend (e.g., lengthwise) in the first direction Z1 to be electrically connected to the circuit portion C at a front position of the battery cell 20 in the first direction Z1.

In an implementation, the first direction Z1 may refer to a direction in which the electrode tab 10 extends, or may refer to a direction in which the battery cell 20 and the circuit portion C are arranged or a direction in which the battery cell 20 and the circuit portion C face each other, and in this case, the front position of the battery cell 20 in the first direction Z1 may refer to a front position of the battery cell 20 facing the circuit portion C, and similarly, a front position of the circuit portion C in the first direction Z1 may refer to a front position of the circuit portion C facing the battery cell 20.

The electrode tab 10 of the battery cell 20 may include the first and second electrode tabs 11 and 12 arranged in the second direction Z2. As will be described below, the first and second electrode tabs 11 and 12 having different polarities may be electrically connected to the circuit portion C through the conductive thermocompression bonding layer 50 on the circuit portion C. Details of the conductive thermocompression bonding layer 50 mediating the electrical connection between the electrode tab 10 of the battery cell 20 and the circuit portion C will be described below in detail.

The circuit portion C may form charge and discharge paths of the battery cell 20. In an implementation, the circuit portion C may form the charge and discharge paths connected to the electrode tab 10 of the battery cell 20, and may form charge and discharge paths between the battery cell 20 and an external device. In an implementation, the external device may correspond to an external load that receives discharge power from the battery cell 20 or an external charger that provides charge power to the battery cell 20. The circuit portion C may form a discharge path from the battery cell 20 to the external load or a charge path from the external charger to the battery cell 20. In an implementation, the circuit portion C may include all charge and discharge paths between the battery cell 20 and an external device, or may contain only some of the charge and discharge paths between the battery cell 20 and the external device.

The circuit portion C according to an embodiment may include a circuit board connected to the battery cell 20, e.g., a circuit board having conductive lines for forming the charge and discharge paths of the battery cell 20, such as a rigid circuit board including a relatively rigid insulating board or a flexible circuit board including a relatively flexible insulating film, and a circuit element configured to obtain state information of the battery cell 20, such as voltage, current, or temperature, or control charging and discharging operations of the battery cell 20, based on obtained state information of the battery cell 20 may be arranged on the circuit board.

In an implementation, the circuit portion C may include a safety element, which may be on the charge and discharge paths of the battery cell 20 and may be configured to capture abnormal conditions of the battery cell 20, e.g., overheating, overcharging, or overdischarging, and may block charge and discharge currents. In an implementation, the safety element may include a variable resistor, which may be on the charge and discharge paths of the battery cell 20, and may have resistance that varies depending on temperature such that, if the battery cell 20 were to be overheated above a preset critical temperature, charge and discharge currents could be forcibly reduced or cut off according to the overheating of the battery cell 20. In an implementation, the safety element may include a positive temperature coefficient (PTC) or a thermal cut-off (TCO). In an implementation, the circuit portion C may include a circuit board including conductive lines thereon for forming the charge and discharge paths of the battery cell 20, and the safety element on the circuit board.

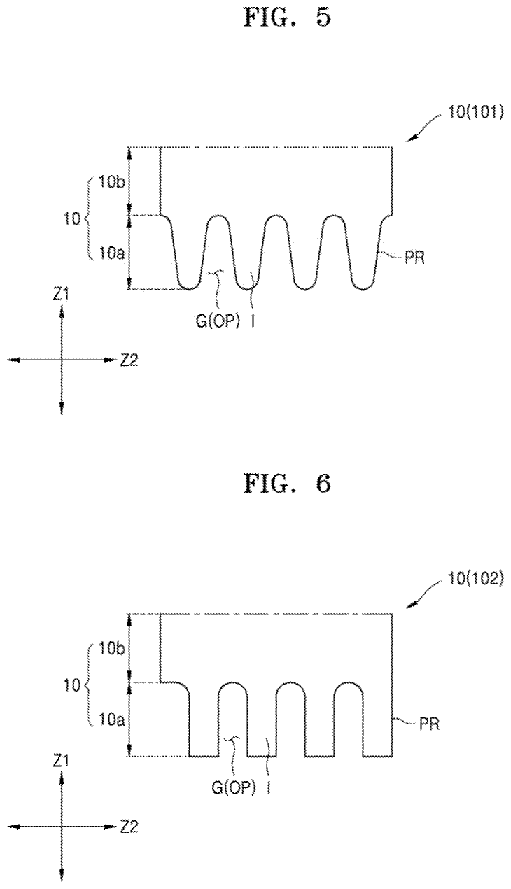

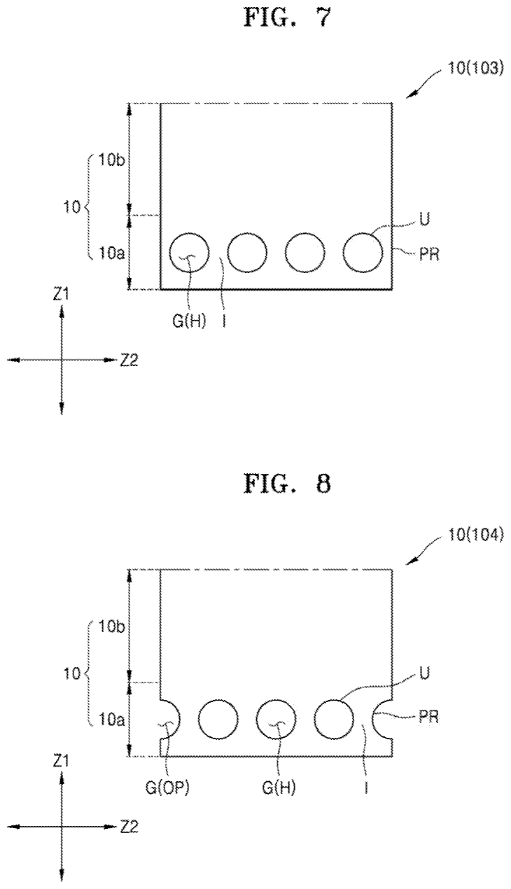

Referring to FIGS. 4 to 8, in an embodiment, the conductive thermocompression bonding layer 50 mediating the electrical connection between the electrode tab 10 and the circuit portion C may include conductive particles 51 and an insulating resin 52 accommodating the conductive particles 51. The electrode tab 10 according to an embodiment may have a structure including an open opening OP or a closed hole H to provide an accommodation space G for accommodating the insulating resin 52. Throughout the present specification, that the electrode tab 10 includes the open opening OP (see FIGS. 5 and 6) means that the electrode tab 10 is open along at least one side along the periphery of the opening OP, and may mean that the accommodation space G provided by the opening OP is open toward the outside of the electrode tab 10. In addition, throughout the present specification, that the electrode tab 10 includes the closed hole H (see FIGS. 7 and 8) may mean that the electrode tab 10 is entirely closed along the periphery of the hole H, such that the accommodation space G provided by the hole H is isolated (e.g., laterally) from the outside (e.g., lateral edge) of the electrode tab 10.

In an implementation, even in a case in which the accommodation space G is in the form of the opening OP (see FIGS. 5 and 6) that is open toward the outside, or the accommodation space G is in the form of a hole H (see FIGS. 7 and 8) isolated from the outside, the accommodation space G for accommodating the insulating resin 52 of the conductive thermocompression bonding layer 50 may be provided.

Referring to FIG. 4, in various embodiments, as the electrode tab 10 and the circuit portion C are pressed toward each other with the conductive thermocompression bonding layer 50 therebetween, the accommodation space G provided by the open opening OP or the accommodation space G provided by the closed hole H may accommodate the insulating resin 52 of the conductive thermocompression bonding layer 50 pushed out between the electrode tab 10 (a strip I) and the circuit portion C, and the conductive particles 51 that have lost fluidity due to discharge of the insulating resin 52 providing the fluidity may mediate an electrical connection between the electrode tab 10 (the strip I) and the circuit portion C while remaining between the electrode tab 10 (the strip I) and the circuit portion C. In an implementation, by accommodating the insulating resin 52 of the conductive thermocompression bonding layer 50, the insulating resin 52 may be discharged from between the electrode tab 10 (the strip I) and the circuit portion C, and the conductive particles 51, which have lost fluidity due to the discharge of the insulating resin 52 that provided the fluidity to the conductive particles 51, may be firmly fixed between the electrode tab 10 (the strip I) and the circuit portion C.

In an implementation, the open opening OP and the closed hole H may provide the accommodation spaces G for the insulating resin 52 and may have different shapes to have different accommodation limits for the insulating resin 52, and it may be stated that the opening OP (see FIGS. 5 and 6) that is open toward the outside of the electrode tab 10 may have a relatively larger accommodation limit than that of the closed hole H (see FIGS. 7 and 8) isolated from the outside of the electrode tab 10. In an implementation, unlike the hole H isolated from the outside of the electrode tab 10, the open opening OP may discharge the insulating resin 52 toward the outside of the electrode tab 10, and accordingly, it may be stated that, in terms of the accommodation limit for the insulating resin 52, the shape of the open opening OP may have a relatively larger accommodation limit than that of the shape of the closed hole H.

In an implementation, in the conductive thermocompression bonding layer 50 between the electrode tab 10 and the circuit portion C, the volume of the insulating resin 52 that needs to be melted from the solid insulating resin 52 by thermocompression bonding and discharged from between the electrode tab 10 (the strip I) and the circuit portion C may vary depending on dimension, such as the thickness of the conductive thermocompression bonding layer 50. In an implementation, the open opening OP (see FIGS. 5 and 6) capable of accommodating a relatively large discharge capacity may be in the electrode tab 10.

Throughout the present specification, that the insulating resin 52 is discharged from between the electrode tab 10 (the strip I) and the circuit portion C or needs to be discharged from between the electrode tab 10 (the strip I) and the circuit portion C may mean that the insulating resin 52, which provided fluidity to the conductive particles 51, may be discharged from between the electrode tab 10 (the strip I) and the circuit portion C according to compression between the electrode tab 10 and the circuit portion C, and then accommodated in the accommodation space G formed in the electrode tab 10. Accordingly, the conductive particles 51 remaining between the electrode tab 10 (the strip I) and the circuit portion C may be firmly fixed.

In a case in which the insulating resin 52 that needs to be discharged between the electrode tab 10 (the strip I) and the circuit portion C cannot be accommodated in the accommodation space G of the electrode tab 10, or the accommodation space G of the electrode tab 10 is not sufficient, and thus, the insulating resin 52 and the conductive particles 51 are trapped between the electrode tab 10 (the strip I) and the circuit portion C, e.g., in a case in which an excessively large amount of insulating resin 52 is trapped between the electrode tab 10 (the strip I) and the circuit portion C, close contact between the electrode tab 10 (the strip I) and the circuit portion C through the conductive particles 51 could be hindered by the excessive amount of insulating resin 52 between the electrode tab 10 (the strip I) and the circuit portion C, or the conductive particles 51 maintaining the fluidity by the insulating resin 52 could be released from between the electrode tab 10 (the strip I) and the circuit portion C. Thus, the electrical connection between the electrode tab 10 and the circuit portion C may not be seamless or the resistance against the electrical connection could increase, which could result in a decrease in the output of the battery pack or a deterioration in the capacity of the battery pack. In an implementation, the electrode tab 10 may include the accommodation space G in the form of the opening OP or the hole H, and the strip I corresponding to a solid part of a solid surrounding the accommodation space G. In an implementation, as illustrated in FIG. 4, the electrode tab 10 may include the accommodation spaces G and strips I alternating in the second direction Z2 (intersecting with the first direction Z1 in which the electrode tab extends).

Referring to FIG. 4, in an embodiment, burrs B accompanying cutting and shaping of the electrode tab 10 may be along an edge of the electrode tab 10. In an implementation, the reliability of the electrical connection between the electrode tab 10 and the circuit portion C may be increased by using the burrs B accompanying cutting and shaping of the electrode tab 10. In an implementation, the burrs B of the electrode tab 10 may be along a boundary between the inside and outside of the electrode tab 10, and the boundary between the inside and outside of the electrode tab 10 may include an overall contour line PR of the electrode tab 10, and may include the contour line PR of the accommodation space G formed in the electrode tab 10. In an implementation, the burrs B of the electrode tab 10 may be along the entire contour line PR defining the shape of the electrode tab 10, including the open opening OP or the closed hole H. In an implementation, the burrs B of the electrode tab 10 may be along only a part of the contour line PR defining the shape of the electrode tab 10, rather than being along the entire contour line PR defining the shape of the electrode tab 10. As such, as will be described below, by trapping the conductive particles 51 between the electrode tab 10 (the strip I) and the circuit portion C even in a case in which the burr B of the electrode tab 10 is along a part of the contour line PR, the density of the conductive particles 51 remaining between the electrode tab 10 (the strip I) and the circuit portion C may be increased, the electrical resistance may be reduced by increasing the conduction area forming the electrical connection between the electrode tab 10 (the strip I) and the circuit portion C through the conductive particles 51 remaining at a high density, and a battery pack with high output and high capacity may be provided.

Referring to FIG. 1, in an embodiment, the electrode tab 10 may be connected to the electrode assembly 20a inside of the battery cell 20 and thus exposed to the outside of the battery cell 20 through the terrace portion T. The electrode tab 10 exposed to the outside of the battery cell 20 may be electrically connected to the circuit portion C through the conductive thermocompression bonding layer 50. Throughout the present specification, that the burr B may be along the contour line PR of the electrode tab 10 may mean that the burr B may be along a part of the contour line PR of the electrode tab 10 exposed to the outside of the battery cell 20 so as to physically interfere with the conductive thermocompression bonding layer 50, and the burr B may not be in a part of the electrode tab 10 exposed to the outside of the battery cell 20, the part extending into the battery cell 20 in the first direction Z1 and connected to the electrode assembly 20a inside the battery cell 20, and the part of the electrode tab 10 extending into the battery cell 20 and connected to the electrode assembly 20a may not correspond to the contour line PR of the electrode tab 10 along which the burr B is formed.

In an implementation, the contour line PR of the electrode tab 10 along which the burr B is formed may correspond to a cutting position of the electrode tab 10, and, e.g., a cutting position for separating each electrode tab 10 from a base metal plate may be the part of the electrode tab 10 extending into the battery cell 20 in the first direction Z1 and connected to the electrode assembly 20a inside the battery cell 20. In an implementation, considering a short circuit or the like between different polarities of the electrode assembly 20a, the burr B may be removed from the part of the electrode tab connected to the electrode assembly 20a inside the battery cell 20.

For reference, in FIGS. 5 to 8, the dashed lines indicating the boundary of the electrode tab 10, may indicate that the electrode tab 10 extends into the battery cell 20 to be connected to the electrode assembly 20a, rather than indicating the end of the electrode tab 10 like the solid line of the electrode tab 10, and accordingly, the dashed lines of the electrode tab 10 may not correspond to the contour line PR of the electrode tab 10 along which the burr B is formed, and may not indicate the end position of the electrode tab 10 like the solid line of the electrode tab 10.

Referring to FIG. 4, in an embodiment, the burr B on the electrode tab 10 may extend in a direction following the cutting direction of the electrode tab 10, and the burr B on the electrode tab 10 may have a directionality along the thickness direction (corresponding to the third direction Z3) of the electrode tab 10. Throughout the present specification, that the burr B on the electrode tab 10 has a directionality means that the burr B of the electrode tab 10 may protrude in any one of the upward and downward directions in the third direction Z3. In an implementation, the electrode tab 10 may protrude toward the top of the electrode tab 10 opposite to the circuit portion C in the third direction Z3 corresponding to the thickness direction of the electrode tab 10, or may protrude downward toward the circuit portion C. As the electrode tab 10 is cut in the thickness direction (the third direction Z3) of the electrode tab 10, e.g., as the base metal plate is cut in the thickness direction (the third direction Z3) of the base metal plate into the electrode tabs 10, each electrode tab 10 may be cut and separated into a certain shape, and because the burr B of the electrode tab 10 may protrude in the thickness direction (the third direction Z3) of the electrode tab 10 in which the cutting is performed, the electrode tab 10 may protrude downwardly toward the circuit portion C or upward toward the side opposite to the circuit portion C according to the orientation of the electrode tab 10 or the orientation of the battery cell 20 in which the electrode tab 10 is drawn out, or according to the relative orientation between the battery cell 20 and the circuit portion C in the third direction Z3.

In an implementation, as illustrated in FIG. 4, the burr B on the electrode tab 10 may protrude downwardly toward the circuit portion C. Here, that the burr B of the electrode tab 10 protrudes downwardly toward the circuit portion C may mean that the burr B of the electrode tab 10 penetrates toward the conductive thermocompression bonding layer 50. In an implementation, the electrode tab 10 and the circuit portion C may face each other with the conductive thermocompression bonding layer 50 therebetween, and the burr B of the electrode tab 10 protruding from the electrode tab 10 at a relatively upper position, toward the circuit portion C at a relatively lower position may penetrate into the conductive thermocompression bonding layer 50 below the electrode tab 10.

In an implementation, the burr B of the electrode tab 10 may protrude in any one of the directions toward the upper and lower sides of the electrode tab 10 in the third direction Z3, and the electrode tab 10 drawn out from the battery cell 20 may protrude downwardly toward the circuit portion C or upward opposite to the circuit portion C, according to the relative orientation between the battery cell 20 and the circuit portion C in the third direction Z3. In an implementation, the burr B of the electrode tab 10 may protrude downwardly toward the circuit portion C, and the burr B penetrating into the circuit portion C or into the conductive thermocompression bonding layer 50 on the circuit portion C may help capture or retain the conductive particles 51 of the conductive thermocompression bonding layer 50, between the electrode tab 10 (the strip I) and the circuit portion C.

In thermocompression bonding between the electrode tab 10 and the circuit portion C, the burr B of the electrode tab 10 may penetrate into the conductive thermocompression bonding layer 50 in the third direction Z3. The burr B of the electrode tab 10 penetrating into the conductive thermocompression bonding layer 50 along the contour line PR of the electrode tab 10 may facilitate the discharge of the insulating resin 52 from between the electrode tab 10 (the strip I) and the circuit portion C while helping to prevent the discharge of the conductive particles 51 to help increase the density of the conductive particles 51 and to help decrease the resistance against the electrical connection between the electrode tab 10 and the circuit portion C, and may discharge the insulating resin 52 between the electrode tab 10 (the strip I) and the circuit portion C to cause the conductive particles 51 that have lost the fluidity provided by the insulating resin 52 to be fixed between the electrode tab 10 (the strip I) and the circuit portion C.

In an implementation, by differentially preventing the components of the conductive thermocompression bonding layer 50, e.g., different components of the conductive particles 51 and the insulating resin 52, from being discharged from between the electrode tab 10 (the strip I) and the circuit portion C, or allowing them to be discharged from between the electrode tab 10 (the strip I) and the circuit portion C, the electrical connection between the electrode tab 10 and the circuit portion C may be formed with low resistance, and a high-power, high-capacity battery pack may be provided. In an implementation, in order to differentially prevent or allow the discharge of the components of the conductive thermocompression bonding layer 50 from between the electrode tab 10 (the strip I) and the circuit portion C, the burr B of the electrode tab 10 may have a smaller size than a distance d (see FIG. 4) of the electrical connection between the electrode tab 10 and the circuit portion C formed by the thermocompression bonding. In an implementation, a protrusion length dt (see FIG. 4) of the burr B of the electrode tab 10 in the third direction Z3 in which the electrode tab 10 and the circuit portion C face each other with the conductive thermocompression bonding layer 50 therebetween may be less than the distance d of the electrical connection between the electrode tab 10 and the circuit portion C.

In an implementation, in order to help prevent the discharge of the conductive particles 51 between the electrode tab 10 (the strip I) and the circuit portion C, and to facilitate the discharge of at least the insulating resin 52, the burr B of the electrode tab 10 may provide for a gap for the discharge of the insulating resin 52. In an implementation, the burr B of the electrode tab 10 may not completely block the portion between the electrode tab 10 and the circuit portion C, and a certain gap may be formed at a position outside the burr B of the electrode tab 10. In an implementation, the distance d (see FIG. 4) of the electrical connection between the electrode tab 10 and the circuit portion C formed by the thermocompression bonding may refer to a gap between the electrode tab 10 and the circuit portion C, which are electrically connected to each other through the thermocompression bonding, and may refer to the thickness of the conductive thermocompression bonding layer 50 filling the gap between the electrode tab 10 and the circuit portion C in the third direction Z3. In an implementation, the distance d (see FIG. 4) of the electrical connection between the electrode tab 10 and the circuit portion C formed by the thermocompression bonding may refer to the thickness of the conductive thermocompression bonding layer 50, which is finally formed through the thermocompression bonding, e.g., the thickness of the conductive thermocompression bonding layer 50 that mediates the electrical connection between the electrode tab 10 and the circuit portion C through the thermocompression bonding. In an implementation, the distance d of the electrical connection between the electrode tab 10 and the circuit portion C may correspond to the diameter of the conductive particles 51 compressed to form a monolayer (of the conductive particles 51) between the electrode tab 10 (the strip I) and the circuit portion C through the thermocompression bonding. In an implementation, the distance d of the electrical connection between the electrode tab 10 and the circuit portion C may be at least equal to the diameter of the conductive particles 51 or may be greater than the diameter of the conductive particles 51. In an implementation, the minimum value of the distance d of the electrical connection between the electrode tab 10 and the circuit portion C may correspond to the diameter of the conductive particles 51 compressed to be arranged in the monolayer, and the protrusion length dt of the burr B of the electrode tab 10 may be less than the diameter of the conductive particles 51 considering a margin.

In an implementation, the burr B of the electrode tab 10 may have a size that is smaller than the distance d of the electrical connection between the electrode tab 10 and the circuit portion C or smaller than the thickness of the conductive thermocompression bonding layer 50. In an implementation, the protrusion length dt of the burr B of the electrode tab 10 protruding downwardly from the electrode tab 10 in the third direction Z3 may be formed in a smaller size than the thickness of the conductive thermocompression bonding layer 50 that mediates the electrical connection between the electrode tab 10 and the circuit portion C through the thermocompression bonding, e.g., the conductive thermocompression bonding layer 50 finally formed through the thermocompression bonding, or than the distance d of the electrical connection between the electrode tab 10 and the circuit portion C In an implementation, the insulating resin 52 may be allowed to be discharged through an extra gap, which corresponds to the thickness of the conductive thermocompression bonding layer 50 excluding the protrusion length dt of the burr B of the electrode tab 10.

The burr B of the electrode tab 10 may be along the contour line PR of the electrode tab 10, and the burr B along the contour line PR of the electrode tab 10 may perform a function of a stopper that helps prevent discharge of the conductive particles 51, such that the conductive particles 51 may remain in an inner position of the electrode tab 10, e.g., in the strip I of the electrode tab 10. In an implementation, the burr B of the electrode tab 10 may be along the entire contour line PR of the electrode tab 10, and the burr B of the electrode tab 10 along the contour line PR of the electrode tab 10 may be along the contour line PR that is the boundary between the inside and outside of the electrode tab 10, so as to help prevent the discharge of the conductive particles 51 not to be separated from the inside of the strip I of the electrode tab 10. In an implementation, the strip I of the electrode tab 10 may correspond to a solid portion of the electrode tab 10, and the entire area of the electrode tab 10 or at least a front end portion 10a located far from the or distal to battery cell 20 in the electrode tab 10 may be divided into the accommodation space G provided by the open opening OP or the closed hole H in the electrode tab 10, and the strip I of the electrode tab 10. As will be described below, the conductive particles 51 restrained by the burrs B of the electrode tab 10 may be arranged in a relatively high proportion on the strip I of the electrode tab 10, and the insulating resin 52 allowed to be discharged from the strip I by the burrs B of the electrode tab 10 may be accommodated in a high proportion in the accommodation space G of the electrode tab 10.

In an implementation, the burr B of the electrode tab 10 may help restrain or contain the conductive particles 51 within (e.g., under) the strip I of the electrode tab 10, and the accommodation space G adjacent to the strip I may provide a space for accommodating the insulating resin 52 discharged from the strip I. In an implementation, depending on the components constituting the conductive thermocompression bonding layer 50, the conductive particles 51 may be present in a high density in the strip I of the electrode tab 10, and the insulating resin 52 may be present at a high density in the accommodation space G outside the strip I of the electrode tab 10. Here, that the conductive particles 51 and the insulating resin 52 are present at a high density may mean that any one of them is present in a relatively higher proportion than is the other. In an implementation, in the relative proportions of the conductive particles 51 and the insulating resin 52 of the conductive thermocompression bonding layer 50, the relative proportion of the conductive particles 51 present in or under the strip I may be greater than the relative proportion of the conductive particles 51 present in the accommodation space G. In an implementation, in the relative proportions of the conductive particles 51 and the insulating resin 52 of the conductive thermocompression bonding layer 50, the relative proportion of the insulating resin 52 present in the accommodation space G may be greater than the relative proportion of the insulating resin 52 present in or under the strip I.

In an implementation, when compared with the average of the relative proportions of the conductive thermocompression bonding layer 50, the conductive particles 51 may be present in or under the strip I of the electrode tab 10 in a relative proportion greater than the average, and the insulating resin 52 may be present in the accommodation space G in a relative proportion greater than the average.

Referring to FIGS. 5 to 8, in various embodiments, the accommodation space G may be in the form of the open opening OP or the closed hole H. In the embodiment illustrated in FIGS. 5 and 6, a concave-convex (e.g., sawtooth) pattern may be along the front end portion 10a of the electrode tab 10 distal to the battery cell 20 in the first direction Z1, so as to form the accommodation space G in the form of the opening OP open to the electrode tab 10. In an implementation, in the concave-convex pattern formed in the front end portion 10a of the electrode tab 10, the strip I may correspond to a solid portion of the electrode tab 10 on which the conductive particles 51 with a relatively high density may be arranged, and the opening OP may correspond to the accommodation space G of the electrode tab 10 in which the insulating resin 52 with a relatively high density may be accommodated. Along the front end portion 10a of the electrode tab 10, e.g., in the front end portion 10a of the electrode tab 10 in the second direction Z2 intersecting with the first direction Z1 in which the electrode tab 10 is drawn out, the strips I and the openings OP (corresponding to the accommodation space G) may be alternately arranged, and the conductive particles 51 with a relatively high density and the insulating resin 52 with a relatively high density may be arranged in the alternating strips I and openings OP (corresponding to the accommodation space G). In an implementation, the strips I and the openings OP (corresponding to the accommodation space G) including large amounts of the respective different components of the conductive thermocompression bonding layer 50 may be alternately arranged in the second direction Z2, and the insulating resin 52 discharged from the strip I may be easily discharged through the openings OP (corresponding to the accommodation space G). As such, through the strips I and openings OP (corresponding to the accommodation space G) alternately arranged in the second direction Z2 intersecting with the first direction Z1 in which the electrode tab 10 is drawn out, it is possible to easily form a region in which the conductive particles 51 are relatively intensively or densely arranged and a region in which the insulating resin 52 is relatively intensively or densely arranged. In an implementation, after heat-sealing the conductive thermocompression bonding layer 50 that is uniform before the heat-sealing, depending on the components of the conductive thermocompression bonding layer 50, the region in which the conductive particles 51 are densely arranged and the region in which the insulating resin 52 is densely arranged may be separated from each other.

Referring to FIGS. 5 and 6, in various embodiments, the concave-convex pattern may have different shapes, and the strip I and the opening OP may be in a complementary form such that a region of the concave-convex pattern in which the strip I is excluded may be the opening OP, and a region in which the opening OP is excluded may be the strip I. The concave-convex pattern may have various shapes and, e.g., as illustrated in FIG. 6, may have a uniform width in the second direction Z2 along the length of the strip I following the first direction Z1 in which the electrode tab 10 is drawn out, or, as illustrated in FIG. 5, may have a variable width in the second direction Z2 along the length of the strip I following the first direction Z1. In an implementation, as illustrated in FIG. 6, a plurality of strips I extending with a uniform width may form a plurality of openings OP extending with a uniform width in a complementary form to the strips I. In an implementation, as illustrated in FIG. 5, a plurality of strips I extending with variable widths may form a plurality of openings OP extending with a variable width in a reverse shape complementary to the strips I. In the embodiment illustrated in FIG. 5, the plurality of strips I may have a variable width where the width gradually decreases in the first direction Z1 from a position adjacent to a base portion 10b of the electrode tab 10 along the length of the strip I in the first direction Z1, e.g., may be formed in the form of a wedge.

As illustrated in FIGS. 5 and 6, in various embodiments, the ends of the strips I or the ends of the openings OP, which are opposite to each other in the first direction Z1 in which the electrode tab 10 is drawn out, may have a rounded shape rather than an angular shape. In an implementation, the strip I and the opening OP may have a form complementary to each other to have the ends at opposite positions in the first direction Z1, and the end of the strip I or the end of the opening OP may have a rounded shape rather than an angular shape. Both the end of the strip I and the end of the opening OP may form the contour line PR of the electrode tab 10, and the end of the strip I or the end of the opening OP may have a round shape having a continuous change rather than an angular shape having an abrupt change, in order to be in a shape in which the burrs B of the electrode tab 10 along the contour line PR of the electrode tab 10 extend continuously without pause.

In an implementation, in the embodiment illustrated in FIG. 5, the electrode tab 10 may have a shape in which both the end of the strip I and the end of the opening OP are rounded. In the embodiment illustrated in FIG. 6, the electrode tab 10 may have a shape in which the end of the opening OP is rounded. For similar reasons, as illustrated in FIGS. 7 and 8, even in a case of having the closed hole H rather than the open opening OP, the hole H may have a round shape rather than an angular shape. In an implementation, in order to be in a shape in which the burrs B of the electrode tab 10 formed along the periphery of the holes H continuously extend to each other without pause, the holes H may have a round shape rather than an angular shape. In an implementation, the hole H may have a circular shape, or the holes H may have various closed curve shapes such as a circular or elliptical shape. In an implementation, in the embodiments illustrated in FIGS. 7 and 8, the electrode tab 10 may include the accommodation spaces G in a plurality of unit shapes U repeatedly arranged in the second direction Z2, and the accommodation space G may have a rounded shape rather than an angular shape, e.g., may include the unit shape U formed in a closed-loop curve such as a circular or elliptical shape.

Referring to FIGS. 7 and 8, in an embodiment, the electrode tab 10 may have a shape in which the unit shape U that provides the accommodation space G in the second direction Z2 (intersecting with the first direction Z1 in which the electrode tab 10 is drawn out), e.g., the unit shape U in a circular shape, may be repeatedly arranged, and the strip I may be between the unit shapes U (the circular unit shapes U) adjacent to each other. In the embodiment illustrated in FIG. 7, the unit shapes U may form the closed holes H providing the accommodation spaces G over the entire width of the electrode tab 10 in the second direction Z2. In the embodiment illustrated in FIG. 8, the unit shapes U may form the closed holes H at inner positions of the electrode tab 10 in the second direction Z2, and may form the openings OP open at both ends (e.g., outer ends or edges) of the electrode tab 10. In an implementation, in the embodiment illustrated in FIG. 8, the circular unit shapes U may form the closed holes H while forming the completely circular unit shapes U at inner positions of the electrode tab 10 in the second direction Z2, and may form the openings OP that are opened in a semicircular shape while coming into contact with the boundary of the electrode tab 10 at both ends of the electrode tab 10 in the second direction Z2. In an implementation, in the embodiment illustrated in FIG. 8, the closed circular hole H and the open semicircular opening OP may have the same diameter or the same curvature.

In an implementation, the accommodation spaces G may be at the front end portion 10a of the electrode tab 10, and the accommodation spaces G may be the open openings OP or the closed holes H. In an implementation, the accommodation spaces G may be only the open openings OP (in the concave-convex pattern) as illustrated in FIGS. 5 and 6, may be only the closed holes H as illustrated in FIG. 7, or may be a combination of the closed holes H and the open openings OP as illustrated in FIG. 8.

In an implementation, as illustrated in FIG. 8, the electrode tab 10 may include the open openings OP at both ends of the electrode tab 10 in the second direction Z2, and the closed holes H at inner positions of the electrode tab 10. In an implementation, the opening OP open toward the outside may provide a relatively larger accommodation space G than does the closed hole H isolated from the outside, e.g., the openings OP that may provide wide accommodation spaces G capable of accommodating a relatively large amount of the insulating resin 52 may be at positions on both sides of the conductive thermocompression bonding layer 50 formed to be wider than the electrode tab 10 in the second direction Z2. The closed holes H alternately arranged together with the strips I in which the conductive particles 51 are captured may be at inner positions of the conductive thermocompression bonding layer 50, to accommodate the insulating resin 52 discharged from the strips I at positions adjacent to the strips I. In an implementation, the accommodation spaces G may be in an appropriate combination of the open openings OP and the closed holes H according to their positions, and the open opening OP and the closed hole H may be in one morphological unit shape U, e.g., the circular unit shapes U repeatedly arranged in the second direction Z2 form, at both ends, the semicircular openings OP with an open portion as a portion of the circular shape is cut, and may form, at inner positions, the closed holes H in a completely circular shape, and thus, the forming process may be simplified.

As illustrated in FIG. 7, when the accommodation space G is the closed hole H of the electrode tab 10, the accommodation space G may be the hole H in a circular shape. As illustrated in FIG. 8, the semicircular openings OP at both ends of the electrode tab 10 may not be formed, and the closed holes H in a completely circular shape may be at inner positions of the electrode tab 10 in the second direction Z2. The electrode tab 10 illustrated in FIG. 7 and the electrode tab 10 illustrated in FIG. 8 may be formed by pressing, toward the electrode tab 10, a punching die including a plurality of circular unit shapes U in the second direction Z2, and by performing a punching process when the electrode tab 10 and the punching die are aligned at different positions in the second direction Z2, the circular holes H in a completely circular shape may be at inner positions of the electrode tab 10 illustrated in FIG. 7, the circular holes H in a completely circular shape may be at inner positions of the electrode tab 10, and the semicircular openings OP may be formed at both ends.

Referring to FIGS. 5 to 8, in an embodiment, the electrode tab 10 may include the base portion 10b (in which the accommodation space G is not formed), and the front end portion 10a, which extends from the base portion 10b in the first direction Z1, provides the accommodation spaces G, and may have the open openings OP or the closed holes H therein. In an implementation, the electrode tab 10 drawn out from the battery cell 20 in the first direction Z1 may include the base portion 10b relatively adjacent or proximate to the battery cell 20, and the front end portion 10a relatively far from or distal to the battery cell 20. In an implementation, the accommodation spaces G may not be in the base portion 10b of the electrode tab 10, and may be in the front end portion 10a of the electrode tab 10. In an implementation, the accommodation spaces G may be a plurality of openings OP or a plurality of holes H. In an implementation, by alternately arranging a plurality of accommodation spaces G (the high-density insulating resin 52) and a plurality of strips (the high-density conductive particles 51) in the second direction Z2, the uniform distribution of the conductive thermocompression bonding layer 50 before thermocompression bonding may be easily transitioned to a non-uniform distribution after the thermocompression bonding, according to the components (the conductive particles 51 and the insulating resin 52) of the conductive thermocompression bonding layer 50. In an implementation, the insulating resin 52 locally discharged from a plurality of places may be directly accommodated through the accommodation space G in an adjacent position, and it is possible to help increase the density of the insulating resin 52 in the accommodation space G while increasing the density of the conductive particles 51 on the strip I by accelerating the discharge of the insulating resin 52.

In various embodiments illustrated in FIGS. 5 to 8, the plurality of accommodation spaces G and the plurality of strips I may be alternately arranged in the second direction Z2. In an implementation, e.g., in the embodiment illustrated in FIGS. 7 and 8, the circular holes H may be the accommodation spaces G between the strips I. In the embodiments illustrated in FIGS. 5 and 6, the openings OP that are open toward the accommodation spaces G between the strips I may be formed. As described above, in various embodiments, the plurality of accommodation spaces G and the plurality of strips I may be alternately arranged along the front end portion 10a of the electrode tab 10 following the second direction Z2. Reference numerals 101, 102, 103, and 104 in FIGS. 5 to 8 refer to the electrode tabs 10, 101, 102, 103, and 104 having different shapes, respectively, and may be collectively referred to as the electrode tab 10, but different reference numbers for the electrode tabs 101, 102, 103, and 104 are assigned in that they have different shapes.

In an implementation, the electrode tab 10 may include a metal material, e.g., copper, aluminum, or nickel, and may include a metal material having high affinity with the first electrode plate or the second electrode plate in the electrode assembly 20a, considering the electrical connection with the electrode assembly 20a forming the battery cell 20.

Referring to FIG. 4, the conductive thermocompression bonding layer 50 between the electrode tab 10 and the circuit portion C may form an electrical connection between the battery cell 20 and the circuit portion C, and may become conductive by thermocompression bonding between the battery cell 20 and the circuit portion C, e.g., thermocompression bonding using a pressing tool TO. In an implementation, the conductive thermocompression bonding layer 50 may refer to a component that is not conductive before the thermocompression bonding, and then becomes conductive through the thermocompression bonding. The conductive thermocompression bonding layer 50 according to an embodiment is different from a metal member that may be recognized as a conductive material regardless of thermocompression bonding, and may refer to a component that changes in conductivity before and after thermocompression bonding. In an implementation, the conductive thermocompression bonding layer 50 may form the electrical connection between the electrode tab 10 and the circuit portion C through a transition from a non-conductive state (or an insulating state) before the thermocompression bonding to a conductive state after the thermocompression bonding, e.g., a transition in the conductivity of the conductive thermocompression bonding layer 50. Throughout the present specification, the transition in the conductivity of the conductive thermocompression bonding layer 50 may refer to a transition from a non-conductive state (or an insulating state) before the thermocompression bonding to a conductive state after the thermocompression bonding, and may refer to a transition to a conductive state through the thermocompression bonding.

In an implementation, the conductive thermocompression bonding layer 50 may include the conductive particles 51 and the insulating resin 52 accommodating the conductive particles 51. In an implementation, the conductive thermocompression bonding layer 50 may include an anisotropic conductive film (ACF).

In an implementation, the insulating resin 52 may be in a solid state below the transition temperature to fix the conductive particles 51, and may then change from the solid state to a liquid or gel state that may have fluidity above the transition temperature. Thus, the conductive particles 51 dispersed in the insulating resin 52 may have fluidity, and the conductive particles 51 having the fluidity may be arranged between the electrode tab 10 and the circuit portion C to form a conductive connection. In an implementation, when the insulating resin 52 that has become fluid at a temperature greater than or equal to the transition temperature is discharged from between the electrode tab 10 (the strip I) and the circuit portion C by pressure provided with heat, e.g., pressure in the third direction Z3 to bring the electrode tab 10 and the circuit portion C closer to each other, the conductive particles 51, which have lost fluidity between the electrode tab 10 (the strip I) and the circuit portion C as the insulating resin 52 that had provided the fluidity is discharged, may be firmly fixed at a position between the electrode tab 10 (the strip I) and the circuit portion C and electrically connect the electrode tab 10 and the circuit portion C to each other. At this time, the insulating resin 52 discharged from between the electrode tab 10 (the strip I) and the circuit portion C may be accommodated in the accommodation spaces G formed in the electrode tab 10, and, e.g., may be accommodated in the accommodation spaces G provided as the open openings OP or the closed holes H. In an implementation, the position between the electrode tab 10 (the strip I) and the circuit portion C at which the conductive particles 51 remain to form the electrical connection may correspond to a region of the electrode tab 10 in which a solid portion is formed, and the accommodation spaces G accommodating the insulating resin 52 discharged from the strip I of the electrode tab 10 may be formed between the strips I. In an implementation, as illustrated in FIGS. 5 to 8, the accommodation spaces G in which the insulating resin 52 is accommodated may not be limited to positions between the strips I, e.g., may include the open openings OP (see FIG. 8) at both ends of the electrode tab 10. In an implementation, the accommodation spaces G accommodating the insulating resin 52 may refer to the accommodation spaces G arranged alternately with the strips I in the second direction Z2, e.g., the outside of both ends of the electrode tab 10 that is not alternated with the strips I at positions outside the electrode tab 10 may also correspond to the accommodation spaces G in the disclosure. In an implementation, the burrs B along the contour line PR of the electrode tab 10 may allow the discharge of the insulating resin 52 from the strips I while confining the conductive particles 51 in the strips I according to the components of the conductive thermocompression bonding layer 50. The insulating resin 52 discharged from the strips I may be discharged to the outside of the electrode tab 10, and in this respect, it may be stated that the outside of the electrode tab 10 may also accommodate the insulating resin 52, and the outside of the electrode tab 10 that is not alternately arranged with the strips may also be defined as the accommodation space G throughout the present specification.

The conductive thermocompression bonding layer 50 may have anisotropy with electrical conductivity characteristics in the third direction Z3 or electrical insulation characteristics in the second direction Z2. In an implementation, the conductive thermocompression bonding layer 50 may have conductivity in the third direction Z3 so as to form the electrical connection between the electrode tab 10 and the circuit portion C in the third direction Z3 corresponding to the direction of the thermocompression bonding, and may have insulation in the second direction Z2 intersecting with the third direction Z3. In an implementation, the conductive thermocompression bonding layer 50 may selectively have conductivity in the third direction Z3 corresponding to the direction of the thermocompression bonding, and may have insulation before and after the thermocompression bonding in the second direction Z2 intersecting with the third direction Z3. In an implementation, the conductive thermocompression bonding layer 50 according to an embodiment may have insulation before the thermocompression bonding in the third direction Z3 corresponding to the direction of the thermocompression bonding, and then have conductivity in the third direction Z3 after the thermocompression bonding, and may not change in conductivity before and after the thermocompression bonding in the second direction Z2 intersecting with the third direction Z3, and have insulation even after the thermocompression bonding. As described above, the conductive thermocompression bonding layer 50 according to an embodiment may selectively have conductivity in the third direction Z3, and have conductivity in the second direction Z2 intersecting with the third direction Z3. In an implementation, even in a case in which a separate conductive thermocompression bonding layer 50 is between the first and second electrode tabs 11 and 12 and the circuit portion C as illustrated in FIG. 2, or in a case in which the first and second electrode tabs 11 and 12 and the circuit portion C are electrically connected to each other through a single conductive thermocompression bonding layer 50 extending across the first and second electrode tabs 11 and 12 as illustrated in FIG. 9, electrical insulation between the first and second electrode tabs 11 and 12 having opposite polarities may be maintained. In an implementation, the electrical connection between the first and second electrode tabs 11 and 12 and the circuit portion C may include an electrical connection between the first and second electrode tabs 11 and 12 having opposite polarities and the circuit portion C, and the electrical connection between the first and second electrode tabs 11 and 12 and the circuit portion C may be made while maintaining electrical insulation from each other. In an implementation, even in a case in which one conductive thermocompression bonding layer 50 is in the second direction Z2 corresponding to the direction of the electrical insulation that intersects with the third direction Z3 corresponding to the direction of the electrical connection, electrical connections between the first and second electrode tabs 11 and 12 having opposite polarities and first and second connection tabs 61 and 62 may not interfere with each other, and the first and second electrode tabs 11 and 12 having opposite polarities may not lead to a short circuit therebetween. As such, when the conductive thermocompression bonding layers 50 respectively forming electrical connections with the first and second electrode tabs 11 and 12 at difference positions is in one unit to extend across the first and second electrode tabs 11 and 12, the electrical connections between the first and second electrode tabs 11 and 12 and the circuit portion C may be made at once by one-time thermocompression bonding through the pressing tool TO (see FIG. 4) simultaneously pressing the first and second electrode tabs 11 and 12.

In the embodiment illustrated in FIG. 2, the conductive thermocompression bonding layers 50 may be separate from each other for the first and second electrode tabs 11 and 12, respectively, and the separate conductive thermocompression bonding layers 50 may be at different positions corresponding to the first and second electrode tabs 11 and 12, respectively, considering that positions of connection with the first and second electrode tabs 11 and 12 are spaced apart from each other.

The circuit portion C may form the charge and discharge paths of the battery cell 20 while being electrically connected to the battery cell 20 through the conductive thermocompression bonding layer 50 and the electrode tab 10. The circuit portion C may form the charge and discharge paths of the battery cell 20, and may control charging and discharging operations of the battery cell 20 by turning on/off switches connected to the charge and discharge paths of the battery cell 20, e.g., may capture an abnormal condition of the battery cell 20, such as overheating, overcurrent, or overvoltage of the battery cell 20, and control the charging and discharging operations of the battery cell 20. In an implementation, the circuit portion C may function as a protection circuit of the battery cell 20 to capture an abnormal condition of the battery cell 20 and control the charging and discharging operations of the battery cell 20, and may take protective measures to prevent a safety accident such as ignition or explosion of the battery cell 20.

The circuit portion C may perform protective operations, such as measuring state information such as temperature, voltage, and current of the battery cell 20, collecting such information to capture an abnormal condition of the battery cell 20, and stopping the charging and discharging operations of the battery cell 20 in response to the abnormal condition of the battery cell 20, and to this end, the circuit portion C may include a plurality of circuit components. The circuit portion C may include a connection tab 60 that forms electrical connections with the first and second electrode tabs 11 and 12 through the conductive thermocompression bonding layer 50, e.g., may include the first and second connection tabs 61 and 62 that forms electrical connections with the first and second electrode tabs 11 and 12, respectively.

According to the disclosure, there may be provided a battery pack capable of easily performing a connection process while increasing the reliability of electrical connection between a battery cell and a circuit portion that forms charge and discharge paths of the battery cell.

One or more embodiments may provide a battery pack capable of easily performing a connection process while increasing the reliability of electrical connection between a battery cell and a circuit portion that forms charge and discharge paths of the battery cell.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a battery cell including an electrode tab drawn out therefrom;
a circuit portion electrically connected to the electrode tab; and
a conductive thermocompression bonding layer, the conductive thermocompression bonding layer conductively connecting the electrode tab and the circuit portion, and including conductive particles and an insulating resin accommodating the conductive particles,
wherein the electrode tab includes at least one accommodation space accommodating the insulating resin therein.

2. The battery pack as claimed in claim 1, wherein the electrode tab includes:
a base portion proximate to the battery cell in a first direction in which the electrode tab is drawn out, the base portion not including the at least one accommodation space therein; and
a front end portion distal to the battery cell in the first direction, the front end portion including the at least one accommodation space therein.

3. The battery pack as claimed in claim 2, wherein the at least one accommodation space is:
an opening, at least one side of the opening being open at a side of the electrode tab, or
a closed hole isolated from the outside of the electrode tab.

4. The battery pack as claimed in claim 3, wherein the electrode tab:
selectively includes one of the opening or the closed hole, or
includes both the opening and the closed hole.

5. The battery pack as claimed in claim 3, wherein:
the at least one accommodation space includes a plurality of accommodation spaces, and
the electrode tab includes a plurality of strips, which are alternately arranged with the plurality of accommodation spaces and are a solid portion of the electrode tab.

6. The battery pack as claimed in claim 5, wherein the plurality of accommodation spaces and the plurality of strips are alternately arranged in a second direction intersecting with the first direction.

7. The battery pack as claimed in claim 6, wherein the plurality of accommodation spaces and the plurality of strips are alternately arranged in the second direction, at the front end portion of the electrode tab.

8. The battery pack as claimed in claim 5, wherein:
the electrode tab further includes a burr along a contour line of the electrode tab,
the burr of the electrode tab restrains the conductive particles on the plurality of strips such that the conductive particles are present on the plurality of strips in a relatively high proportion when compared to the insulating resin, and
the insulating resin is present in the plurality of accommodation spaces adjacent to the strips in a relatively high proportion when compared to the conductive particles.

9. The battery pack as claimed in claim 8, wherein, in relative proportions of the conductive particles and the insulating resin of the conductive thermocompression bonding layer, the relative proportion of the conductive particles present on the plurality of strips is greater than the relative proportion of the conductive particles present in the plurality of accommodation spaces.

10. The battery pack as claimed in claim 8, wherein, in relative proportions of the conductive particles and the insulating resin of the conductive thermocompression bonding layer, the relative proportion of the insulating resin present in the plurality of accommodation spaces is greater than the relative proportion of the insulating resin present on the plurality of strips.

11. The battery pack as claimed in claim 5, wherein the front end portion of the electrode tab has a concave-convex pattern in which the plurality of strips and openings of the plurality of accommodation spaces alternate.

12. The battery pack as claimed in claim 11, wherein:
the plurality of strips and the openings have shapes that are complementary to each other,
the plurality of strips have a variable width along a length of the strips following the first direction, in a second direction intersecting with the first direction, and
the openings have a variable width in a reverse shape in the second direction.

13. The battery pack as claimed in claim 11, wherein an end of the strip of the concave-convex pattern or an end of the opening, which are opposite to each other in the first direction, has a rounded shape.

14. The battery pack as claimed in claim 5, wherein unit shapes of the plurality of accommodation spaces are repeatedly arranged at the front end portion of the electrode tab such that the plurality of strips are between adjacent unit shapes.

15. The battery pack as claimed in claim 14, wherein the unit shapes of the plurality of accommodation spaces are closed holes.

16. The battery pack as claimed in claim 14, wherein the unit shapes of the plurality of accommodation spaces:
are closed holes at inner positions of the electrode tab, and
are open openings at both ends of the electrode tab at an outer edge of the electrode tab.

17. The battery pack as claimed in claim 14, wherein the unit shapes have a closed-loop curve.

18. The battery pack as claimed in claim 14, wherein:
the unit shapes are a circular shape, and
a circular shape formed by a closed hole and a semicircular shape formed by an open opening have a same diameter or a same curvature.

19. The battery pack as claimed in claim 1, wherein:
the electrode tab includes a first electrode tab and a second electrode tab having polarities opposite to each other, and
the first electrode tab, the second electrode tab, and the circuit portion are electrically connected to each other through a single conductive thermocompression bonding layer therebetween extending across the first electrode tab and the second electrode tab.
